(19) United States
(12) Patent Application Publication
(10) Pub. No.: US 2010/0206681 A1
(43) Pub. Date: Aug. 19, 2010

(54) CLUTCH COVER ASSEMBLY

(75) Inventors: Hajime Komori, Osaka (JP); Hiroshi Uehara, Osaka (JP)

Correspondence Address: GLOBAL IP COUNSELORS, LLP, 1233 20TH STREET, NW, SUITE 700, WASHINGTON, DC, 20036-2680, US

(73) Assignee: EXEDY CORPORATION, Neyagawa-shi, Osaka (JP)

(21) Appl. No.: 12/439,890

(22) PCT Filed: Oct. 24, 2007
(86) PCT No.: PCT/JP2007/070688

§ 371 Date: Mar. 4, 2009

(30) Foreign Application Priority Data
Nov. 16, 2006 (JP) 2006-310034

(51) Int. Cl. F16D 13/44

(52) U.S. Cl. 192/70.27

(57) ABSTRACT

A clutch cover assembly (1) comprises a clutch cover (2), a pressure plate (3), a diaphragm spring (4), a cone spring (30), a support plate (20), and stud pins (10). The cone spring (30) is disposed on the flywheel side of the diaphragm spring and generates a load against the biasing force of the diaphragm spring. The support plate (20) is disposed on the flywheel side of the cone spring (30) and supports the cone spring (30) and the diaphragm spring (4). The stud pins (10) connect the support plate (20) to the clutch cover (2). Each stud pin (10) has a first fixture part (16) fixed to the clutch cover (2) and a second fixture part (17) holding the support plate (20) in the axial direction.

### TECHNICAL FIELD

The present invention generally relates to a clutch cover assembly. More particularly, the present invention pertains to a clutch cover assembly, which presses a frictional member of a clutch-disc assembly to a flywheel of an engine and releases a pressure of the frictional member applied to the flywheel.

### BACKGROUND OF THE INVENTION

A clutch cover assembly is generally assembled onto a flywheel of an engine and is employed for transmitting a driving force of the engine towards a transmission. Such a clutch cover assembly is mainly structured with a clutch cover fixed to the flywheel, a pressure plate arranged to press a frictional member of a clutch-disc assembly to the flywheel, and a diaphragm spring for pressing the pressure plate towards the flywheel. The diaphragm spring is configured with an annular elastic portion and plural lever portions that extend radially inwardly from an inner circumferential rim of the annular elastic portion. As well as having a function for pressing the pressure plate towards the flywheel, the diaphragm spring has a lever function for releasing a pressure thereof applied to the pressure plate.

A pressing load characteristic exhibits an inverted U-shape, which indicates an increase of a load, within an effective usable range. Therefore, in accordance with an increase of an abrasion of the frictional member, the pressing load of the diaphragm spring in a clutch-engaged state is increased. In other words, when the frictional portion of the clutch-disc assembly is worn out, a releasing load is increased. Therefore, a larger clutch pedal depressing force is required.

Accordingly, as a mechanism for cutting a peak of the pressing load characteristic, a clutch cover assembly, which includes a peak cutting mechanism, has been proposed (see Japanese Utility Model No. 3-22131Y, for example).

According to the known clutch cover assembly, a cone spring is employed as an elastic member that generates a load for counteracting the load of the diaphragm spring when the frictional member is worn out. The cone spring is supported by plural supporting portions, which are formed by bending a part of the clutch cover, along with the diaphragm spring. The cone spring is disposed at an inner circumferential side of a protruding portion of the pressure plate.

Further, as illustrated in FIG. 6, a clutch cover assembly 501, of which a cone spring 530 is supported by plural stud pins 510 and an annular supporting plate 520, has been proposed. According to the clutch cover assembly 501, a clutch cover 502 and the supporting plate 520 are connected to each other by means of the stud pins 510. The cone spring 530 is supported by the supporting plate 520 along with a diaphragm spring 504. Each of the stud pins 510 includes a columned body portion 511, which extends from the clutch cover 502 towards a flywheel 551, and a head portion 512, which is formed at an end portion of the body portion 511 and of which diameter is larger than that of the body portion 511. Further, plural semicircular cutouts 521 are formed at an inner circumferential portion of the supporting plate 520. The body portion 511 of each stud pin 510 is fitted into the cutout 521.

Thus, according to the known clutch cover assembly 501, the cone spring 530 is supported by the supporting plate 520, which is hooked at ends of the stud pins 510.

According to the clutch cover assembly 501, an improvement of a lever ratio of the diaphragm spring 504 is required in order to reduce the releasing load. In order to improve the lever ratio, each stud pin 510, which supports the diaphragm spring 504, is required to be positioned circumferentially further outwardly. In such a condition, a radial space defined between a protruding portion 503b of the pressure plate 503 and each stud pin 510 is arranged to be smaller, thereby reducing flexibility in design of the cone spring 530, which is employed for cutting the peak of the pressing load characteristic.

As described above, according to the clutch cover assembly including a peak cutting function, a need exists for effectively using a space around the cone spring and increasing design flexibility.

### SUMMARY OF THE INVENTION

An object of the present invention is to increase design flexibility of a clutch cover assembly including a peak cutting function.

A clutch cover assembly according to a first aspect of the present invention is employed for pressing a frictional member of a clutch disc assembly to a flywheel of an engine and for releasing a pressure of the frictional member applied to the flywheel. The clutch cover assembly includes a clutch cover, pressure plate, a diaphragm spring, an elastic member, a supporting member, and a plurality of connecting members. The clutch cover is fixed to the flywheel. The pressure plate is arranged to be axially movable relative to the clutch cover and to be rotatable therewith. Further, the pressure plate is arranged to press the frictional member to the flywheel. The diaphragm spring is supported by the clutch cover and biases the pressure plate towards the flywheel. The elastic member is disposed at a flywheel-side of the diaphragm spring and generates a load against a biasing force of the diaphragm spring. The supporting member is disposed at a flywheel-side of the elastic member and supports the elastic member and the diaphragm spring. The connecting members connect the supporting member and the clutch cover. The connecting member includes a first fixture portion being fixed to the clutch cover and a second fixture portion for interposing the supporting member in an axial direction.

Due to the above described clutch cover assembly, the pressure plate is biased towards the flywheel by the diaphragm spring. Consequently, the frictional member of the clutch disc assembly is interposed between the pressure plate and the flywheel. Accordingly, a torque is transmitted from the flywheel of the engine to the clutch disc assembly by a frictional resistance generated between each of the components described above.

When the frictional member is worn out, an axial position of the pressure plate in a clutch-engaged state is offset towards the flywheel. In such a condition, the biasing force of the diaphragm spring in the clutch-engaged state is increased, while the load counteracting the biasing force of the diaphragm spring is generated. Therefore, the biasing force applied to the pressure plate is reduced, thereby preventing the releasing load from being increased due to the frictional member.

In such a condition, the supporting member, which supports the elastic member and the diaphragm spring, is interposed by the second fixture portion of each connecting member. Therefore, a connecting strength between the supporting member and the connecting member is improved in comparison with the known art, and the second fixture portion of the connecting member can be downsized. Accordingly, a space around each connecting member is effectively used, thereby increasing the design flexibility of the clutch cover assembly.

A clutch cover assembly of a second aspect of the present invention is the clutch cover assembly according to the first aspect of the present invention wherein the second fixture portion includes a body portion, a small-diameter portion and a head portion. The body portion is formed in a columned shape and is disposed at an axial space defined between the clutch cover and the supporting member. The small-diameter portion extends from an end portion of the body portion towards the flywheel. Further, an outer diameter of the small-diameter portion is smaller than an outer diameter of the body portion. The head portion is provided at an end portion of the small-diameter portion. Further, an outer diameter of the head portion is larger than the outer diameter of the small-diameter portion.

A clutch cover assembly of a third aspect of the present invention is the clutch cover assembly according to the second aspect of the present invention, wherein the outer diameter of the head portion is equal to or smaller than the outer diameter of the body portion.

A clutch cover assembly of a fourth aspect of the present invention is the clutch cover assembly according to any of the second and third aspects of the present invention, wherein the supporting member includes a body portion and a supporting portion. The body portion of the supporting member includes a plurality of bores, through which the small-diameter portion of the second fixture portion is inserted. Further, the body portion of the supporting member is interposed by the second fixture portion. The supporting portion of the supporting member is disposed at an outer circumferential side of the body portion for supporting the elastic member.

A clutch cover assembly of a fifth aspect of the present invention is the clutch cover assembly according to any of the first to fourth aspects of the present invention, wherein the first ring member is provided at an axial space defined between the clutch cover and the diaphragm spring. The second ring member is provided at an axial space defined between the diaphragm spring and the supporting member. Further, the second ring member is positioned further radially outwardly than the first fixture portion.

A clutch cover assembly of a sixth aspect of the present invention is the clutch cover assembly according to any of the first to fourth aspects of the present invention, wherein a ring member is provided at an axial space defined between the clutch cover and the diaphragm spring. Further, the supporting member includes a protruding portion, which is positioned further radially outwardly than the first fixture portion and contacts the diaphragm spring in the axial direction.

### BRIEF DESCRIPTION OF DRAWINGS

FIG. 1 is an elevational view schematically illustrating a clutch cover assembly (first embodiment).

FIG. 2 is a longitudinal cross-sectional view schematically illustrating the clutch cover assembly (first embodiment).

FIG. 3 is an enlarged cross-sectional view illustrating a portion around a stud pin (first embodiment).

FIG. 4 is a longitudinal cross-sectional view illustrating a clutch cover assembly (modified embodiment).

FIG. 5 is a longitudinal cross-sectional view illustrating the clutch cover assembly (modified embodiment).

FIG. 6 is a longitudinal cross-sectional view illustrating a clutch cover assembly (known art).

### DETAILED DESCRIPTION OF THE PREFERRED EMBODIMENTS

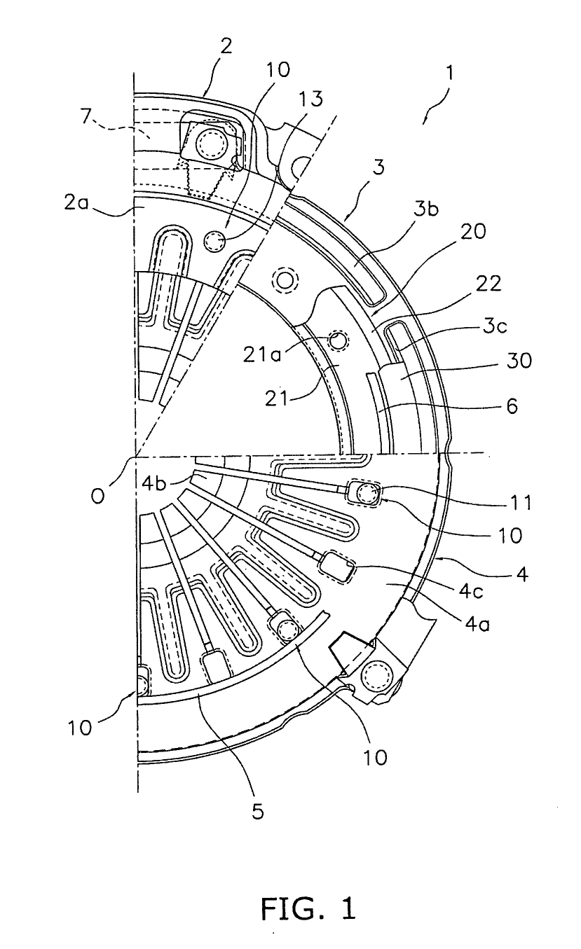

An embodiment of the present invention will be described hereinafter with reference to the attached drawings.

[1. Overview of clutch cover assembly] A clutch cover assembly 1 illustrated in FIGS. 1 to 3 includes a push-type diaphragm spring mechanism. The clutch cover assembly 1 is employed for engaging a clutch mechanism by pressing a frictional member 53 of a clutch disc assembly to a flywheel 51 of an engine and releasing a pressure applied to the frictional member 53 for canceling an engagement of the clutch mechanism. The frictional member 53 includes a cushioning mechanism, which has a frictional facing and a cushioning plate and which is arranged to be flexibly bent in an axial direction within a predetermined range.

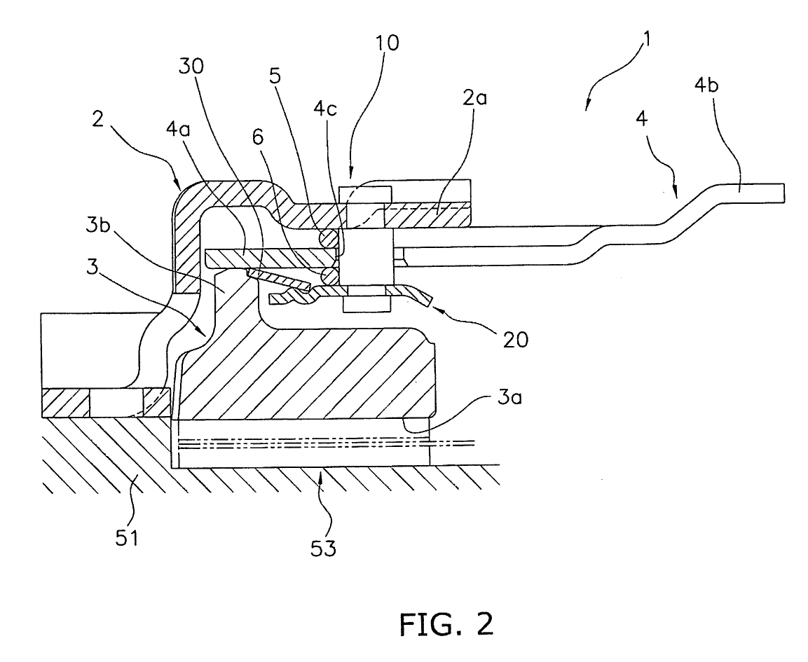

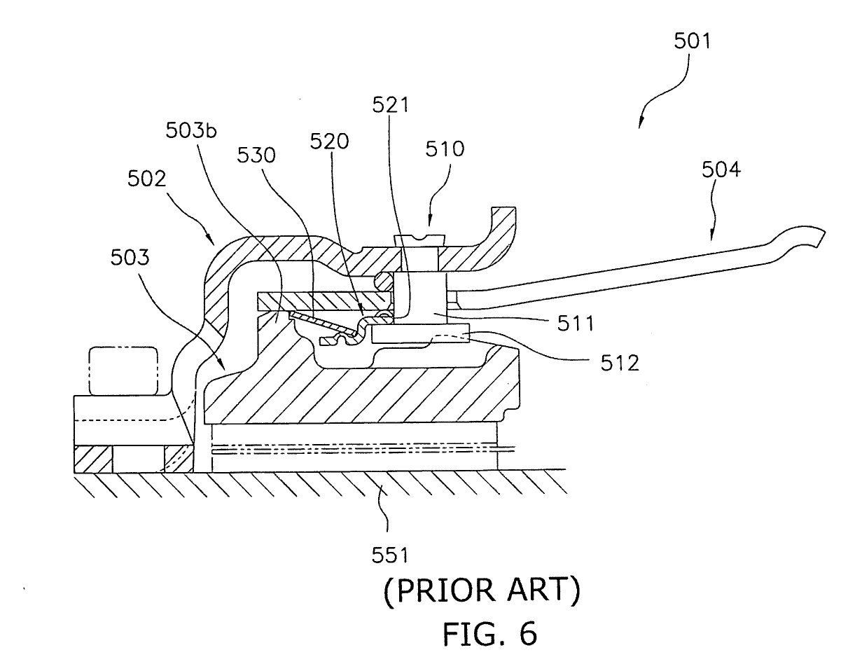

O illustrated in FIG. 1 indicates a rotational axis of the flywheel 51 and the clutch cover assembly 1. Hereinafter, a lower side in FIGS. 2-6, is assigned as “engine-side axial direction,” while an upper side in FIGS. 2-6 is assigned as “transmission-side axial direction.”

As illustrated in FIGS. 1 and 2, the dutch cover assembly 1 mainly includes a clutch cover 2, a pressure plate 3, and a diaphragm spring 4.

The clutch cover 2 is an approximately tray-like plate member. An outer circumferential portion of the clutch cover 2 is fixed to the flywheel 51 by means of bolts, for example. The clutch cover 2 includes a disc-shaped portion 2a, which faces the flywheel 51 having a space therebetween in the axial direction.

The pressure plate 3 is an annular member including a pressing surface 3a at a side portion facing the flywheel 51. The frictional member 53 of the clutch disc assembly is disposed between the pressing surface 3a of the pressure plate 3 and the flywheel 51. The pressure plate 3 further includes an annular protruding portion 3b at a side portion, which is opposite to another side portion where the pressing surface 3a is formed. The annular protruding portion 3b protrudes in the axial direction. The pressure plate 3 is supported, by means of plural strap plates 7 (see FIG. 1), so as to be axially movable and relatively unrotatable to the clutch cover 2.

The diaphragm spring 4 is a disc-shaped member disposed between the pressure plate 3 and the clutch cover 2 and is structured with an annular elastic portion 4a and plural lever portions 4b extending radially inwardly from an inner circumferential portion of the annular elastic portion 4a. The annular elastic portion 4a contacts the protruding portion 3b of the pressure plate 3. Slits are formed between the adjacent lever portions 4b, respectively. Further, oval-shaped bores 4c are formed at radially outer end portions of the slits, respectively. Further, a push-type release mechanism (not illustrated) contacts end portions of the lever portions 4b of the diaphragm spring 4. The release mechanism is structured with, for example, a release bearing.

The diaphragm spring 4 is supported so as to be axially elastically deformable relative to the clutch cover 2. More specifically, plural stud pins 10, each of which serves as a connecting member, are fixed at the disc-shaped portion 2a of the clutch cover 2. Further, an annular supporting plate 20, which serves as a supporting member, is fixed to the plural stud pins 10 at end portions thereof, which is adjacent to the flywheel 51. An inner circumferential portion of the annular elastic portion 4a of the diaphragm spring 4 is interposed between the disc-shaped portion 2a of the clutch cover 2 and the supporting plate 20 via wire rings 5 and 6.

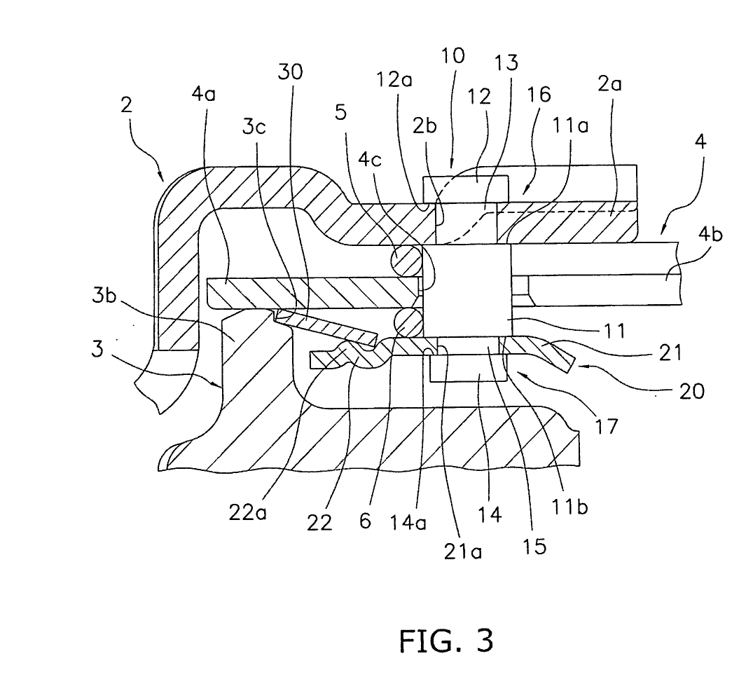

Further, a cone spring 30 is disposed between the supporting plate 20 and the annular elastic portion 4a of the diaphragm spring 4. The cone spring 30 serves as an elastic member. In a clutch-engaged state as illustrated in FIG. 2, the cone spring 30 is not compressed in a condition where the frictional member 53 is not worn out. The cone spring 30 is a member for leveling a pressing load characteristic of the diaphragm spring 4. When abrasion of the frictional member 53 progresses, the cone spring 30 applies a load to the annular elastic portion 4a against the biasing force of the diaphragm spring 4 to the annular elastic portion 4a. Thus, an increase of a releasing load is prevented even when the abrasion of the frictional member 53 progresses.

[2. Structure of portion around stud pin] Hereinafter, a structure of the stud pins 10 will be described in detail with reference to FIG. 3. FIG. 3 illustrates an enlarged cross sectional view of one of the stud pins 10.

As illustrated in FIG. 3, the clutch cover 2 and the supporting plate 20 are connected to each other by means of the stud pin 10. More specifically, the stud pin 10 includes a first fixture portion 16, which is fixed to the clutch cover 2, and a second fixture portion 17, which is fixed to the supporting plate 20. The first and second fixture portions 16 and 17 are fixed to the clutch cover 2 and the supporting plate 20, respectively, by caulking, such as by means of rivets.

The supporting plate 20 includes an annular body portion 21 and a supporting portion 22. The body portion 21 is fixed to the second fixture portion 17 of the stud pin 10 by caulking. The supporting portion 22 is formed at an outer circumferential portion of the body portion 21 so as to be integral therewith. The supporting portion 22 is in contact with the cone spring 30.

The stud pin 10 includes a columned body portion 11, a first small-diameter portion 13, a second small-diameter portion 15, a first head portion 12, and a second head portion 14. The body portion 11 is disposed between the disc-shaped portion 2a of the clutch cover 2 and the supporting plate 20. The first small-diameter portion 13 extends from the body portion 11 in a direction that is opposite to the flywheel 51. The second small-diameter portion 15 extends from the body portion 11 towards the flywheel 51. The first head portion 12 is formed at an end portion of the first small-diameter portion 13. The second head portion 14 is formed at an end portion of the second small-diameter portion 15. The first fixture portion 16 is structured with the body portion 11, the first small-diameter portion 13, and the first head portion 12. The second fixture portion 17 is structured with the body portion 11 the second small-diameter portion 15, and the second head portion 14. The body portion 11 of each stud pin 10 is inserted through the corresponding bore 4c of the diaphragm spring 4.

The first small-diameter portion 13 is a columned portion of which an outer diameter is smaller than an outer diameter of the body portion 11. The first small-diameter portion 13 is fitted into a bore 2b formed at the disc-shaped portion 2a of the clutch cover 2. An outer diameter of the first head portion 12 is larger than the outer diameter of the first small-diameter portion 13 and is equal to or smaller than the outer diameter of the body portion 11.

The second small-diameter portion 15 is a columned portion of which an outer diameter is smaller than the outer diameter of the body portion 11. The second small-diameter portion 15 is fitted into a bore 21a formed at the body portion 21 of the supporting plate 20. An outer diameter of the second head portion 14 is larger than the outer diameter of the second small-diameter portion 15 and is equal to or smaller than the outer diameter of the body portion 11.

The first and second head portions 12 and 14 are formed by caulking in a manufacturing process. Accordingly, the disk-shaped portion 2a of the clutch cover 2 is interposed between the body portion 11 and the first head portion 12, while the supporting plate 20 is interposed between the body portion 11 and the second head portion 14. More specifically, a first supporting surface 11a and a second supporting surface 11b are respectively formed at axial side portions of the body portion 11. The first head portion 12 includes a third supporting surface 12a at a side portion adjacent to the flywheel 51. The first supporting surface 11a and the third supporting surface 12a are in contact with both surfaces of the disc-shaped portion 2a of the clutch cover 2 in a condition where an interposing force is applied thereto. The second head portion 14 includes a fourth supporting surface 14a at a side portion which is opposite to the flywheel 51. The second supporting surface 11b and the fourth supporting surface 14a are in contact with the body portion 21 of the supporting plate 20 in a condition where an interposing force is applied thereto.

Thus, due to the structure of the first fixture portion 16, the disc-shaped portion 2a of the clutch cover 2 and the stud pin 10 are arranged to be rigid members. Further, due to the structure of the second fixture portion 17, the body portion 21 of the supporting plate 20 and the stud pin 10 are also arranged to be rigid members. Accordingly, high connecting strength is secured at the first and second fixture portions 16 and 17 (particularly, higher connecting strength of the second fixture portion 17 is secured in comparison with a known art). Therefore, even when a load is applied to the supporting plate 20 in the axial direction, the deformation of the supporting plate 20 is restrained.

Further, an outer circumferential portion of the body portion 21 of the supporting plate 20 (i.e., a portion disposed at a radially outer side of the body portion 11 structuring the second fixture portion 17) contacts the wire ring 6 in the axial direction. Radial positions of the wire rings 5 and 6 are determined by the body portion 11 of each of the plural stud pins 10. An inner circumferential portion of the body portion 21 of the supporting plate 20 is entirely bent towards the pressure plate 3.

The supporting portion 22 formed at the outer circumferential portion of the body portion 21 of the supporting plate 20 includes a contact portion 22a, which contacts the cone spring 30. The contact portion 22a is formed by bending an outer circumferential rim of the body portion 21 so as to posses an S-shaped cross section. An inner circumferential portion of the cone spring 30 is supported by the contact portion 22a of the supporting portion 22, while the outer circumferential portion of the cone spring 30 is supported by the protruding portion 3b of the pressure plate 3. A recessed portion 3c is formed at a radially inner side portion of the protruding portion 3b. The outer circumferential portion of the cone spring 30 is fitted to the recessed portion 3c of the pressure plate 3.

Due to the above described structure, the diaphragm spring 4 and the cone spring 30 are supported so as to be elastically deformable in the axial direction relative to the clutch cover 2. Further, the cone spring 30 applies the load, which counteracts the biasing force of the diaphragm spring 4, to the annular elastic portion 4a thereof. Therefore, according to the clutch cover assembly 1, even when the abrasion of the frictional member 53 progresses, an increase of the releasing load is prevented.

[3. Engaging and releasing operations of clutch mechanism] According to the clutch cover assembly 1, the annular elastic portion 4a of the diaphragm spring 4 applies the pressing load to the pressure plate 3 in a condition where the release mechanism (not illustrated) does not apply a load to an end of each lever portion 4b of the diaphragm spring 4. Consequently, the frictional member 53 of the clutch disc assembly is pressed to the flywheel 51, and a torque is accordingly transmitted therefrom to the clutch disc assembly (the clutch-engaged state).

When the releasing mechanism (not illustrated) presses an end of each lever portion 4b of the diaphragm spring 4 towards the engine, an outer circumferential portion of the annular elastic portion 4a of the diaphragm spring 4 is forced to move in the transmission-side axial direction about the wire ring 5 as a fulcrum. Therefore, the annular elastic portion 4a does not press the pressure plate 3, and the pressure plate 3 is separated from the frictional member 53 by the strap plate 7. Then, the frictional member 53 is separated from the flywheel 51 (a clutch-released state).

[4. Effect] According to the clutch cover assembly 1, the supporting plate 20, which supports the cone spring 30 and the diaphragm spring 4, is held by the second fixture portion 17 of each stud pin 10. Therefore, in comparison with the known art, the connecting strength between the supporting plate 20 and the stud pin 10 is improved, and the second fixture portion 17 (more specifically, the second head portion 14 thereof) of the stud pin 10 is downsized. Accordingly, a space around each stud pin 10 (more specifically, a space around the second head portion 14 of the stud pin 10) can be effectively used, thereby increasing the design flexibility of the clutch cover assembly 1.

Further, since the connecting strength of the second fixture portion 17 is improved, the supporting force of the supporting plate 20 is also increased. Consequently, the cone spring 30 having high rigidity is employed for the clutch cover assembly 1, and the design flexibility of the clutch cover assembly 1 is increased.

[5. Modified embodiment] The present invention is not to be construed as limited by the embodiment described above. Variations and changes may be made without departing from the spirit of the present invention.

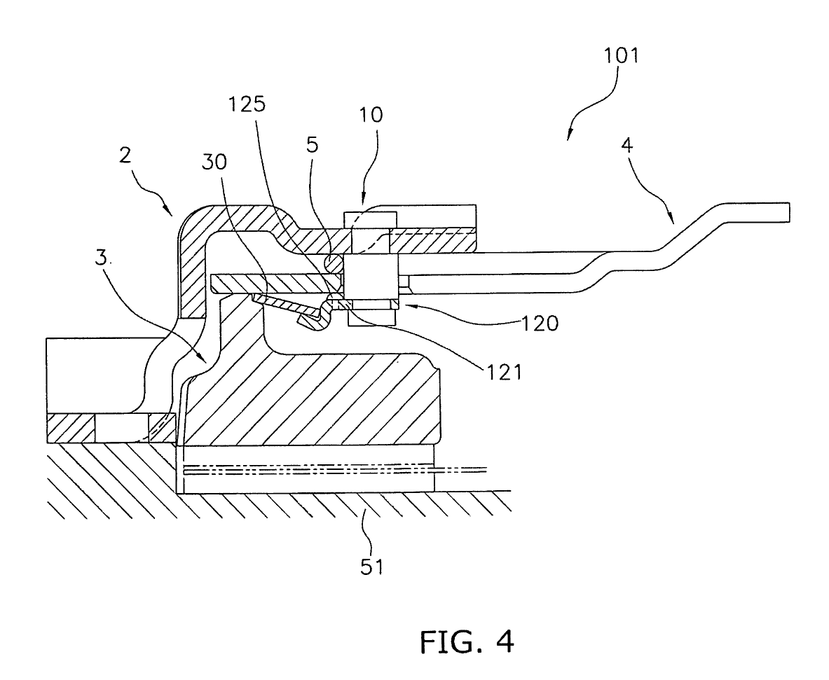

For example, as illustrated in FIG. 4, a supporting plate 120 of a clutch cover assembly 101 may include plural supporting protrusions 125, which protrude in the axial direction so as to be away from the flywheel 51, at a portion corresponding to the wire ring 6 of the supporting plate 20 in place of the wire ring 6. Due to the supporting plate 120, the supporting protrusions 125 are formed by press-working, in which a part of a body portion 121 of the supporting plate 120 is pressed in the axial direction.

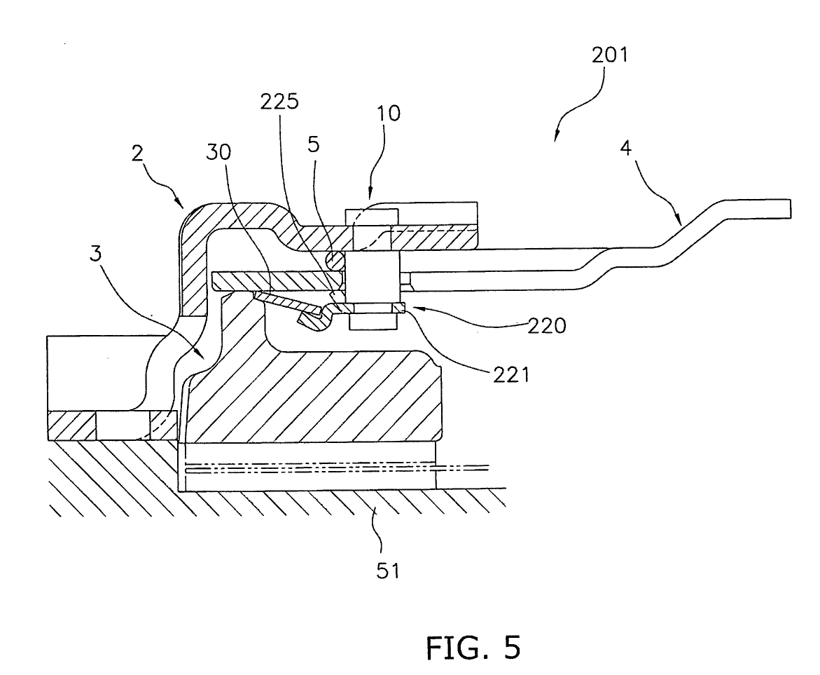

Further, as illustrated in FIG. 5, a supporting plate 220 of a clutch cover assembly 201 may include pawl-like supporting protrusions 225 in place of the wire ring 6. Due to the supporting plate 220, the supporting protrusions 225 are formed by bending a part of a body portion 221 of the supporting plate 220.

According to such clutch cover assemblies 101 and 201, an axial size of a portion around the stud pin 10 is downsized in comparison with a condition where the wire ring 6 is provided. Therefore, an axial length of the stud pin 10 is reduced. Accordingly, a space around the stud pin 10 can be effectively used.

### INDUSTRIAL APPLICABILITY

According to a clutch cover assembly of the present invention, design flexibility thereof is increased. Therefore, the clutch cover assembly is effectively applied for a technical field pertaining to a clutch apparatus.

1. A clutch cover assembly being configured to press a frictional member of a clutch disc assembly against a flywheel of an engine and being configured to release a pressure of the frictional member applied to the flywheel, the clutch cover assembly comprising:
a clutch cover being fixed to the flywheel;
a pressure plate being arranged to be axially movable relative to the clutch cover and to be rotatable therewith, the pressure plate being arranged to press the frictional member against the flywheel;
a diaphragm spring being supported by the clutch cover and biasing the pressure plate towards the flywheel;
an elastic member being disposed at a flywheel-side of the diaphragm spring and generating a load against a biasing force of the diaphragm spring;
a supporting member being disposed at a flywheel-side of the elastic member and supporting the elastic member and the diaphragm spring; and
a plurality of connecting members connecting the supporting member and the clutch cover,
the connecting member including a first fixture portion being fixed to the clutch cover and a second fixture portion interposing the supporting member in an axial direction.

2. A clutch cover assembly according to claim 1, wherein
the second fixture portion includes a columned body portion disposed at an axial space defined between the clutch cover and the supporting member, a small-diameter portion extending from an end portion of the body portion towards the flywheel, the small-diameter portion of which an outer diameter is smaller than an outer diameter of the body portion, and a head portion disposed at an end portion of the small-diameter portion, the head portion of which an outer diameter is larger than the outer diameter of the small-diameter portion.

3. A clutch cover assembly according to claim 2, wherein
the outer diameter of the head portion of the second fixture portion is equal to or smaller than the outer diameter of the body portion thereof.

4. A clutch cover assembly according to claim 3, wherein
the supporting member includes a body portion having a plurality of bores, through which the small diameter portion of the second fixture portion is inserted, and being interposed by the second fixture portion, and a supporting portion being disposed at an outer circumferential side of the body portion supporting the elastic member.

5. A clutch cover assembly according to claim 4, wherein
a first ring member is provided at an axial space defined between the clutch cover and the diaphragm spring,
a second ring member is provided at an axial space defined between the diaphragm spring and the supporting member, and
the second ring member is positioned further radially outwardly than the first fixture portion.

6. A clutch cover assembly according to claim 4, wherein
a ring member is provided at an axial space defined between the clutch cover and the diaphragm spring, and
the supporting member includes a protruding portion being positioned further radially outwardly than the first fixture portion and contacting the diaphragm spring in the axial direction.

7. A clutch cover assembly according to claim 3, wherein
a first ring member is provided at an axial space defined between the clutch cover and the diaphragm spring,
a second ring member is provided at an axial space defined between the diaphragm spring anti the supporting member, and
the second ring member is positioned further radially outwardly than the first fixture portion.

8. A clutch cover assembly according to claim 3, wherein
a ring member is provided at an axial space defined between the clutch cover and the diaphragm spring, and
the supporting member includes a protruding portion being positioned further radially outwardly than the first fixture portion and contacting the diaphragm spring in the axial direction.

9. A clutch cover assembly according to claim 2, wherein
the supporting member includes a body portion having a plurality of bores, through which the small diameter portion of the second fixture portion is inserted, and being interposed by the second fixture portion, and a supporting portion being disposed at an outer circumferential side of the body portion supporting the elastic member.

10. A clutch cover assembly according to claim 9, wherein
a first ring member is provided at an axial space defined between the clutch cover and the diaphragm spring,
a second ring member is provided at an axial space defined between the diaphragm spring and the supporting member, and
the second ring member is positioned further radially outwardly than the first fixture portion.

11. A clutch cover assembly according to claim 9, wherein
a ring member is provided at an axial space defined between the clutch cover and the diaphragm spring, and
the supporting member includes a protruding portion being positioned further radially outwardly than the first fixture portion and contacting the diaphragm spring in the axial direction.

12. A clutch cover assembly according to claim 2, wherein
a first ring member is provided at an axial space defined between the clutch cover and the diaphragm spring,
a second ring member is provided at an axial space defined between the diaphragm spring and the supporting member, and
the second ring member is positioned further radially outwardly than the first fixture portion.

13. A clutch cover assembly according to claim 2, wherein
a ring member is provided at an axial space defined between the clutch cover and the diaphragm spring, and
the supporting member includes a protruding portion being positioned further radially outwardly than the first fixture portion and contacting the diaphragm spring in the axial direction.

14. A clutch cover assembly according to claim 1, wherein
a first ring member is provided at an axial space defined between the clutch cover and the diaphragm spring,
a second ring member is provided at an axial space defined between the diaphragm spring and the supporting member, and
the second ring member is positioned further radially outwardly than the first fixture portion.

15. A clutch cover assembly according to claim 1, wherein
a ring member is provided at an axial space defined between the clutch cover and the diaphragm spring, and
the supporting member includes a protruding portion being positioned further radially outwardly than the first fixture portion and contacting the diaphragm spring in the axial direction.
